(19) United States
(12) Patent Application Publication
(10) Pub. No.: US 2024/0399558 A1
(43) Pub. Date: Dec. 5, 2024

(54) Ergonomic Grip for Knife

(71) Applicant: Juan Bernardo Montes de Oca, San Diego, CA (US)

(72) Inventor: Juan Bernardo Montes de Oca, San Diego, CA (US)

(21) Appl. No.: 18/679,028

(22) Filed: May 30, 2024

Related U.S. Application Data
(60) Provisional application No. 63/469,685, filed on May 30, 2023.

(51) Int. Cl. B25G 1/10; B26B 3/00

(52) U.S. Cl. CPC B25G 1/102; B26B 3/00

(57) ABSTRACT

An ergonomic grip is provided for use with a knife. The grip has a body with a first recess for an ergonomic positioning of the thumb of a user gripping the knife. The body also includes a second recess providing a second pathway for an ergonomic positioning of the index finger of the user. A third recess forms a third pathway for the ergonomic positioning of the index finger of a user therein during a gripping of the knife.

This application claims priority to U.S. Provisional patent application Ser. No. 63/469,685 filed on May 30, 2023.

### FIELD OF THE INVENTION

The present device relates to knives, such as those used in kitchens. More particularly, the disclosed device relates to an ergonomic grip for engagement to or inclusion in the handle of such knives.

### BACKGROUND OF THE INVENTION

Knives have been in existence for millennia and employed for multiple uses. Kitchen knives are widely used by professional chefs as well as the general population in the preparation of food.

Most modern cooking preparation can be accomplished with a few general purpose knives. Such may include a large chef knife, a paring knife and some sort of serrated bladed knife for cutting breads and the like. Generally, such kitchen knives are constructed with a handle for holding by the user and a sharp blade extending from one end of the handle.

With knives being used daily in home and commercial kitchens, cuts and lacerations to the user are some common accidents during use. Oddly, blunt knives are a common cause of such injuries as they require excessive force and tend to slip from the grip of the user while cutting or chopping food. However, extremely sharp knives are equally to blame, and when using very sharp knives, the user may not initially be aware they have cut themself.

Statistics have shown in the past that one of the largest causes of knife injuries in the kitchen occurs during the cutting of bread, such as bagels. Another frequent cause of knife injuries occurs while cutting and dicing food. A primary cause of such knife injuries occurs when the handle slips from the hand of the user.

For chefs and other professionals who use knives for work, not only are they at risk from cutting by their knives, long term handle holding can result in overwork of tendons and joints of their hand and arm due to the constant need to exert gripping force to the knife handles.

The forgoing background concerning conventional knives and the limitations related therewith are intended to be illustrative and not exclusive, and they do not imply any limitations on the invention described and claimed herein. Various other limitations of the related art of knives are known or will become apparent to those skilled in the art upon a reading and understanding of the specification below and the accompanying drawings.

### SUMMARY OF THE INVENTION

The ergonomic grip device herein disclosed provides users of conventional kitchen knives the ability to achieve a much more secure and comfortable grip on the knife handle. In addition, the grip provided is ergonomic in relation to their hand and fingers and in use, requires less force to maintain the knife during use.

In one particularly preferred mode of the device and system herein which may retrofit existing knives, the ergonomic grip is provided by a removably attachable grip component. This allows the user to move the grip component from knife to knife as they work. However, the grip component may also be provided by formation thereof as part of the knife handle. In another preferred mode of the device herein, which is employable with newly manufactured knives, the ergonomic grip may be formed as part of the handle in a unitary structure therewith.

The grip component has a body which may be formed of a polymeric material, such as acrylic, plastic, resin, and other composites, or in some cases of metal. However, the body may also be formed of other materials such as wood where desirable.

The body of the engageable grip component has a slot formed on a lower surface thereof which is configured for engagement to a knife at a mounting location. The currently preferred mounting location for the body of the grip component herein is at a location where the knife blade is engaged to and projects from the front end of a knife handle. The slot is formed to both engage the knife blade and to curve around the sides and in some cases the bottom of the handle so as to provide a very stable removable engagement that is not easily dismounted or rotated.

So positioned in removable engagement to the knife, the body of the grip component has three finger grip paths positioned on the exterior surface thereof. A first such grip path is formed to wrap around a first side of the grip component body and is sized to allow the thumb of the user to ergonomically curve around the exterior of the body. A ridge may overhang an upper surface of the thumb of the user to form an especially stable engagement with the thumb when so positioned.

A second grip path is formed on the exterior surface of the grip component body on a side opposite the first grip path. This second grip path is curved for an ergonomic positioning of the index finger of the user therein during use. The downward curve of the second grip path in a direction from the top of the knife handle toward the bottom thereof, causes the user to curl their index finger downward and around the body of the device during positioning of their index finger therein.

The third grip path is also formed into the exterior surface of the grip component body and also runs along a downward curve along a path somewhat parallel to the downward curve of the second grip path in which the index finger is located. This third grip path allows the user to place their middle finger therein, and in a curved position in a location adjacent the second grip path in which the curved index finger is located.

This curved positioning of both the index finger in the second grip path, adjacent the middle finger of the user located in the third grip path, positions both the index finger and middle finger in an natural ergonomic alignment. This alignment allows the user to impart more force to their thumb toward the two aligned fingers on the opposite side of the handle to achieve a better grip upon the knife handle and knife during use. Further, it automatically positions the hand of the user to an ergonomic grip, where the two fingers curve downward and around one side of the knife handle in a natural economic positioning. The thumb of the user is imparting grip force in a natural position with the thumb curving along a line toward the two fingers as it is naturally positioned when not gripping the knife.

This multi-grip path configuration thus places the index finger and the middle finger of the hand of the user in a natural or ergonomic curve which those fingers follow when not gripping anything. It also serves to cause the thumb to exert force toward the two fingers rather than having the thumb wrap around the handle in an unnatural position. As such, the user is provided with a more secure and comfortable ergonomic grip of the knife on which the grip component is engaged.

While it is preferred to provide the grip component in a manner which is removably engageable to multiple knives, the device herein can also be provided as a formed component of the exterior surface of the knife handle, for newly manufactured knives. As a consequence, the invention herein includes the ergonomic grip for a knife in both the removably engageable mode as well as a permanently engaged mode which is formed with newly manufactured knives.

With respect to the above description, before explaining at least one preferred embodiment of the herein disclosed ergonomic grip component in detail, it is to be understood that the invention is not limited in its application to the details of construction and to the arrangement of the components in the following description or illustrated in the drawings. The ergonomic configuration of the grip component for a knife handle herein described and disclosed is capable of other embodiments and of being practiced and carried out in various equivalent ways which will become obvious to those skilled in the art upon reading this disclosure. Also, it is to be understood that the phraseology and terminology employed herein are for the purpose of description and should not be regarded as limiting.

As such, those skilled in the art subsequent to reading this disclosure will appreciate that the conception upon which this disclosure is based, may readily be utilized as a basis for the designing of other ergonomic grip components which are engaged to knife handles, and substantially equivalent structures methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially”, unless otherwise specifically defined, means plus or minus five percent.

It is an object of the present invention to provide a secure and ergonomic grip for the hands of users of knives.

It is an additional object of this invention to provide such an ergonomic grip which may be removably engaged to multiple knives to provide the user a secure and comfortable means to grip multiple different knives during use.

It is an additional object of this invention to provide the same ergonomic knife grip by the formation of such into the exterior surface of a knife handle.

These and other objects, features, and advantages of the present ergonomic knife handle gripping component as well as the advantages thereof over existing prior art, which will become apparent from the description to follow, are accomplished by the improvements described in this specification and hereinafter described in the following detailed description which fully discloses the ergonomic knife invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed ergonomic knife handle grip component and configuration herein. It is intended that the embodiments and figures disclosed herein are to be considered illustrative of the invention herein, rather than limiting in any fashion.

In the drawings:

FIG. 1 depicts an exploded view showing the body of the grip component herein positioned to form a removable engagement at a mounting point on a knife and showing a first pathway on a first side for the thumb of the user.

FIG. 2 shows the body of the grip component of FIG. 1 removably engaged at an engagement point on the knife.

FIG. 2A shows the body of the grip component from an opposite side view of FIG. 2 showing a second pathway for the index finger and third pathway for the middle finger of the hand of the user.

FIG. 3 depicts the body of the grip component having a first grip path configured for positioning a thumb of the user therein in a natural horizontal curve.

FIG. 4 depicts the body of the grip component from an opposite side from that of FIG. 3 showing the downward curving second grip path for the index finger of the user and a substantially parallel downward path of the third grip path for positioning of the middle finger of the user therein.

FIG. 5 shows a view of the body of the grip from a bottom or lower edge showing a recess configured to slide over the top of a knife handle at the engagement point thereof to the blade.

FIG. 6 shows a left side view of the body of the grip showing the thumb recess which is shown in FIG. 9.

FIG. 7 depicts the opposite side view from FIG. 6 of the body of the grip showing the recessed pathway for the index finger of the user, as in FIG. 8.

FIG. 8 shows the grip component removably engaged with a knife and showing the downward paths of both the index finger positioned in the first second grip path and the middle finger of the user positioned in the third grip path, adjacent to the index finger.

FIG. 9 shows the user gripping the knife with the grip component operatively engaged and showing the thumb of the user positioned in the horizontally curving first grip path and exerting force toward and against the two fingers in the curved engagement, as in FIG. 5.

FIG. 10 shows an overhead view of the grip component removably engaged to the knife and the thumb and fingers of the user forming a compression engagement to the grip component in an ergonomic positioning.

FIG. 11 depicts a close up view of the grip component removably engaged to the engagement point on the knife and the thumb positioned in the first grip path causing it to curve horizontally toward the knife blade as well as the two fingers on the opposite side.

FIG. 12 shows a bottom view of the grip component in a right handed configuration engaged with the knife and showing the thumb of the user positioned within the first grip path, and the index finger and middle finger of the user curving downward along the second and third grip paths.

FIG. 12A shows a bottom view of the grip component in a left handed configuration opposite that of FIG. 12 wherein the first, second, and third grip paths are on opposite sides from that of FIG. 12.

FIG. 13 depicts a right side surface of the grip component herein formed into the exterior surface of a knife handle for a left handed user.

FIG. 14 depicts a left side surface of the grip component herein formed into the exterior surface of a knife handle for a right handed user.

### DETAILED DESCRIPTION OF THE INVENTION

In this description, the directional prepositions of up, upwardly, down, downwardly, front, back, top, upper, bottom, lower, left, right, first, second, and other such terms refer to the ergonomic grip component for a knife either formed as part of the handle or an attachment therefor, as it is oriented and appears in the drawings and all such terms are used for convenience only and such are not intended to be limiting or to imply that the disclosed device has to be used or positioned in any particular orientation.

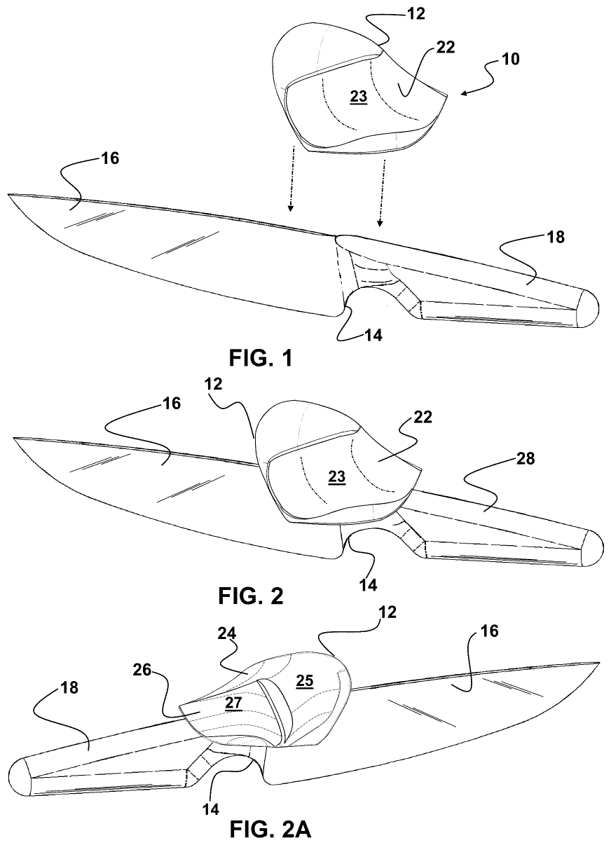

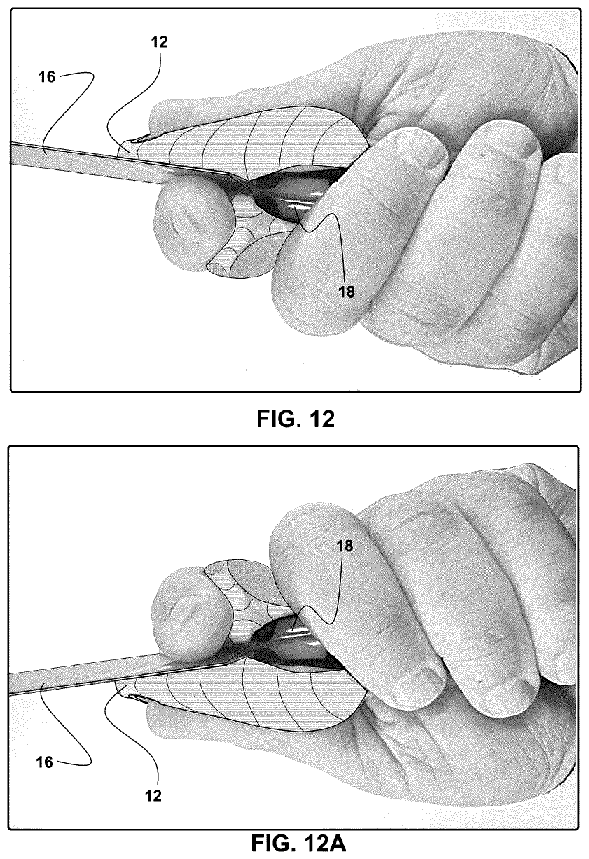

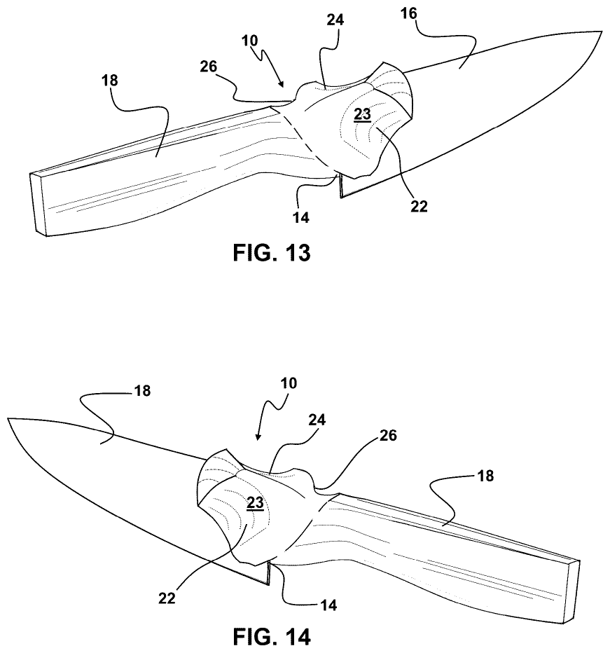

Now referring to drawings in FIGS. 1-14, wherein similar components are identified by like reference numerals, there is seen in FIG. 1 an exploded view of the device 10 showing the body 12 of the grip component herein. It should be noted that the device 10 may be formed in a unitary structure as part of the handle as in FIGS. 13 and 14 for newly manufactured knives.

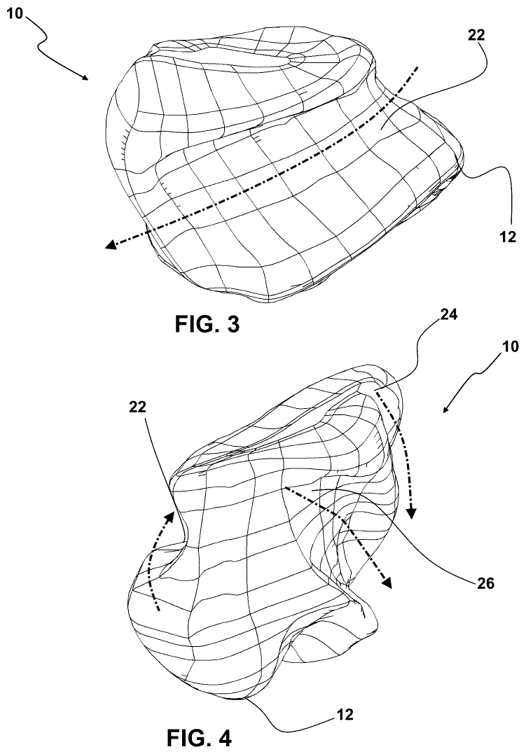

As shown in FIG. 1 and other figures with the removable mode, the body 12 of the device 10, configured for a right handed user, is positioned wherein it may be lowered to form a removable engagement with a knife 14, such as in FIG. 2. The pathways, noted herein, when the device 10 has a body 12 configured for a left handed user, would be reversed. However, for the sake of brevity in this application, the majority of the description herein is for the device 10 having a body 12 configured for a right handed user.

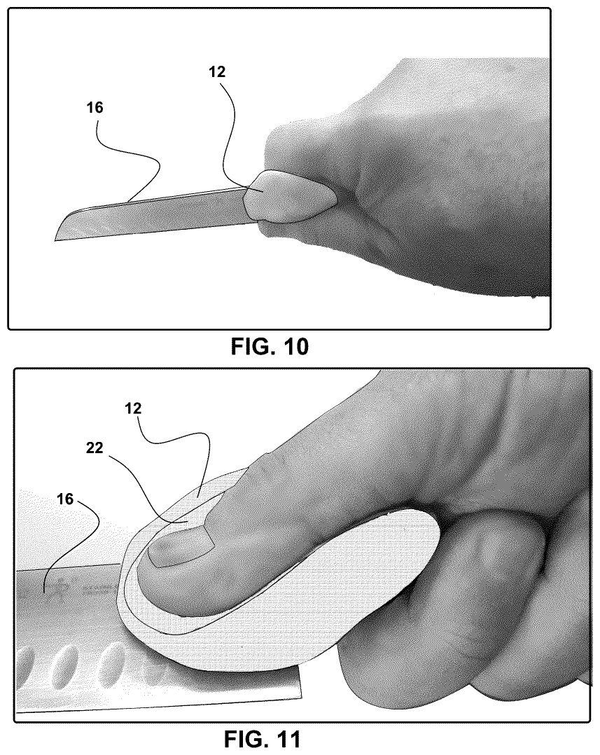

This removable engagement mode of the device is, preferably, a frictional engagement wherein a slot 20, shown in FIG. 5, is configured to slide upon the engagement end of a knife handle 18 where that handle 18 connects to the knife blade 14 which extends therefrom. For example, the width of the slot 20, where it slides upon the handle 18, would be slightly smaller or equal to the width of the handle 18 and the width of the slot 20, where it slides upon the blade 16, will be equal to or slightly smaller than the width of the blade 16.

The material, forming the body 12, is preferably polymeric or plastic or the like for comfort, a non-slip grip, and for easy cleaning of the device 10. Such materials may include acrylic, plastic, resin, and composites and may also include silicone or rubber or other plastic or synthetic material. This is because such materials, conventionally, have a durometer to allow for the body 12 to slightly compress, when engaged with the finger and thumb of the user, and also allows for forming the slot 20 narrower than the width of the handle 18 and the blade 16 on which it engages.

In FIG. 2 is depicted the body 12 of the grip component in an engaged positioning wherein it is removably or, in some cases, permanently engaged at an engagement point on the knife 14. As noted, the current preferred engagement point is at a position where the body 12 will slide on and cover an end portion of the handle 18 at the point where it is engaged to the blade 16 which projects from the handle 18. The body 12, thus, will cover a portion of the handle 18 and a portion of the blade 16, once engaged. The same positioning would be preferred where the body is formed upon the exterior surface of the handle 18, such as in FIGS. 13 and 14. As can be seen in FIG. 2, the first grip path 22 curves around the exterior of the body 12 and is located to allow an ergonomic placement of the thumb of the user within this first path 22. As noted, the device can be configured for left handed persons which would reverse the positioning of the first path 22 to the right side of the body 12.

A depiction of the device 10 from the opposite side of the body 12 opposite that of FIG. 2 is shown in FIG. 2A. As shown, a second grip path 24 follows a curving path down the right side surface of the body 12 and a third grip path 26 runs in a curved path adjacent the second grip path 24. Configured for a left handed person, the second grip path 24 and third grip path 26 will be on the opposite side of the body 12.

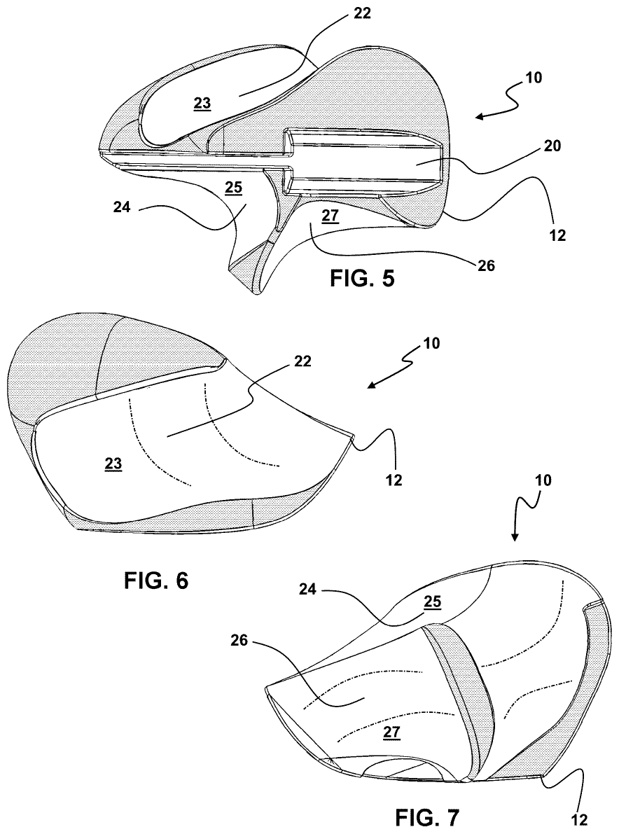

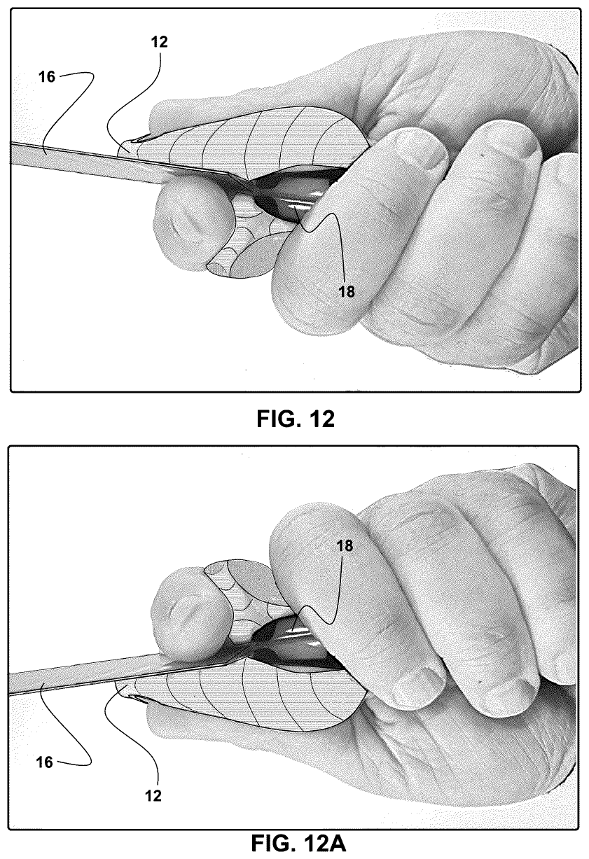

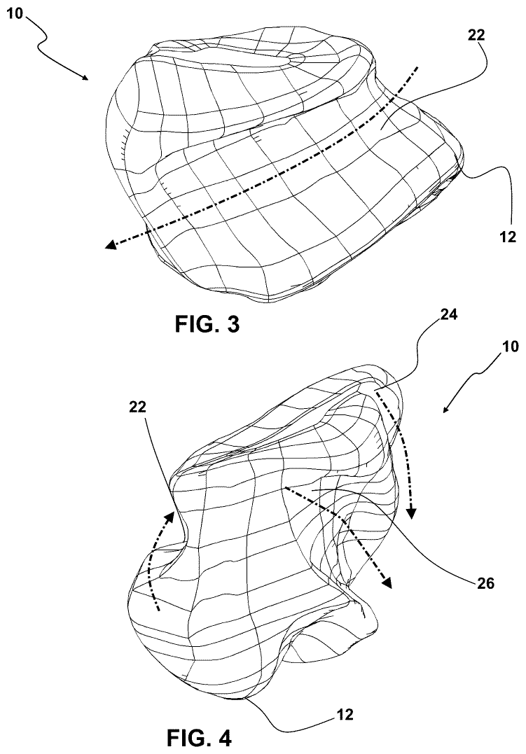

In FIG. 3 and in FIG. 6 is shown the body 12 of the grip component device 10 showing a first grip path 22 for the thumb of the user extending down one side of the body 12. This first grip path 22 is defined by a recess formed into a first side surface of the body 12 which is configured for the comfortable and ergonomic positioning of a thumb of the user therein in a natural horizontal curve when the user is right handed. Such a positioning is shown in FIG. 9, for example.

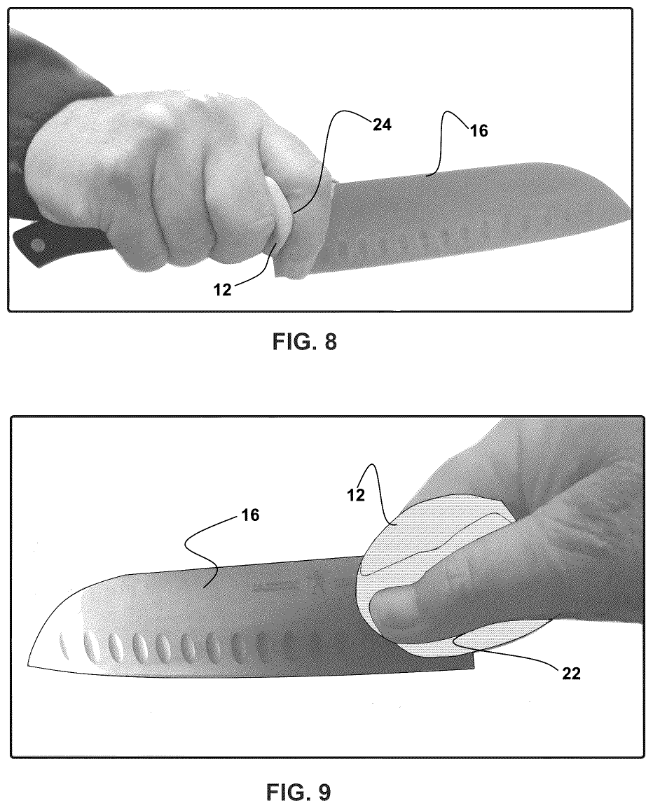

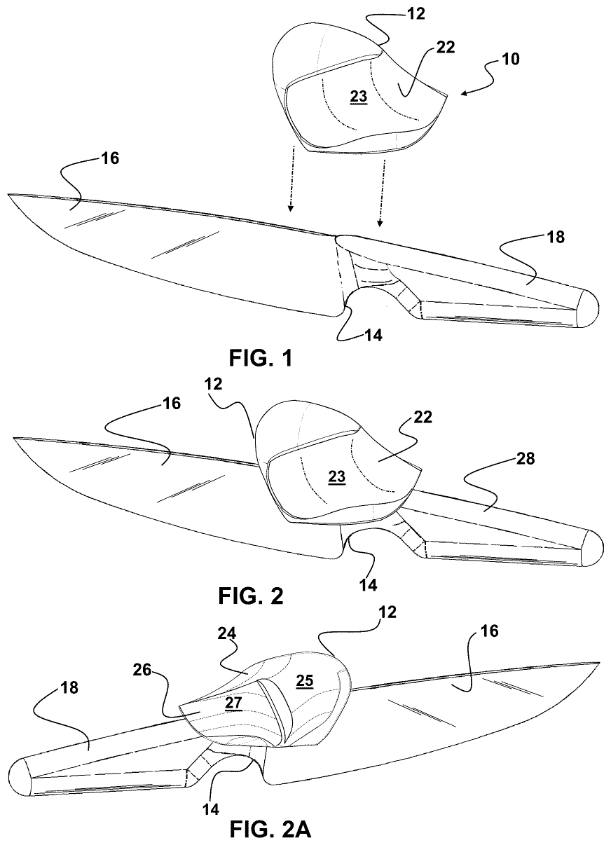

Shown in FIG. 4 is the body 12 of the grip component device 10 from a rearward perspective and an opposite side from that of FIG. 3. As shown, there is a second grip path 24 formed into the exterior of the body 12, which follows a downward curve. This second grip path 24, formed by a second recess in the body 12, is sized for the positioning of the index finger of the user therein, as for example shown in FIG. 8. With the thumb positioned within the first grip path 22, the index finger of the user is neutrally in position to follow the ergonomic second grip path 24 when holding the knife 14.

Also shown in FIG. 4 is a third grip path 26 which is formed in a third recess to ergonomically hold and seat the middle finger of the user therein, as in FIG. 8. The positioning of the middle finger of the user while the thumb is positioned in the first grip path 22 and the index finger is positioned within the second grip path 24 achieves the ergonomic grip of the knife by the user.

In FIG. 5, there is shown a view of the body 12 of the grip device 10 from a bottom or lower edge view. As shown, the first grip path 22 is defined by a first recess 23 formed into the exterior surface of the body 12 forming the device 10. Also shown is the second grip path 24 defined by a second recess 25 formed into the exterior surface of the body 12 and the third grip path 26 defined by a third recess 27 in the exterior surface of the body of the device 10.

Formed into the body 12 of the grip device 10 on this lower edge is slot 20 which is configured to slide over the top edge of a portion of the knife handle 18 at the engagement point thereof to the blade 16, along with a portion of that blade 16. This slot 20, so formed, locates the body 12 of the grip device 10 in the engaged position in a preferred location for holding the knife 14 comfortably.

A first portion of the slot 20 is of a width equal to or slightly smaller than the width of the handle 18 over which it slides. A second portion of the slot 20, which communicates into the first portion, is sized with a width there across which is equal to or slightly smaller than the width of the blade 16 where it engaged to the handle 18 of the knife 14. As noted, where the body 12 is formed of pliable material which will slightly compress, the slot 20 will grip upon the blade 16 and handle 18 at this mounting point. It should be noted that the body 12 may be configured with a slot 20 which just engages over the handle 18 at an end thereof adjacent where the blade 16 projects from the handle in some instances and such is anticipated for knives with shorter blades 18.

In FIG. 6 is shown a left side view of the body 12 of the grip device 10 configured for a right handed user showing the first grip path 22 which forms a thumb recess for positioning the thumb of the user therein when gripping the device 10 and the knife 14. This positioning and the grip is shown, for example, in FIG. 9 and, as noted, would be positioned on the opposite side of the body 12 for a left handed user.

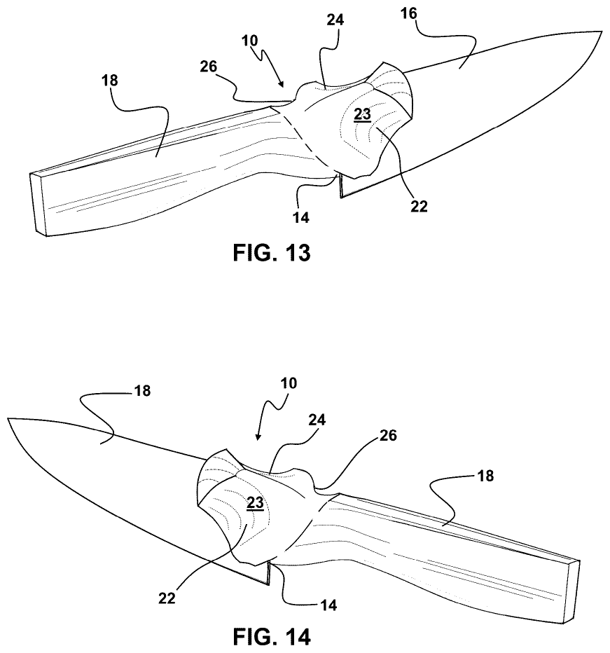

FIG. 7 depicts an opposite side view of the body 12 from FIG. 6. As shown, the second grip path 24 is positioned to hold the middle finger of the user therein, as in FIG. 8, and the third grip path 26 is positioned to hold the middle finger of the hand of a user.

Additionally shown in FIG. 8 is the grip component device 10 having the body 12 thereof in a mounted position at the mounting point on the knife 14 which, as noted, is either on the handle 18 alone or on the handle 18 and a portion of the blade 16 at the intersection of the blade 16 with the end of the handle 18. In this engaged position, the body 12 of the grip component device 10 provides an ergonomic positioning for both the index finger positioned in the second grip path 24 and the middle finger of the user positioned in the third grip path 26 adjacent to the index finger.

Shown in FIG. 9 is the body 12 of the grip component device 10 in a right handed configuration, operatively located in the engaged position at the mounting point from a view of the opposite side from FIG. 8. As shown, the thumb is comfortably and ergonomically located within the first grip path 22.

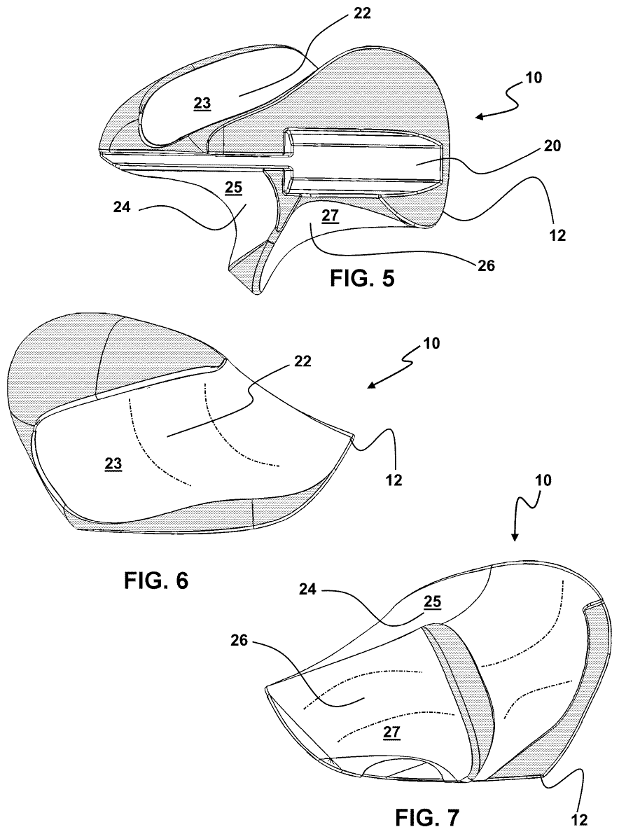

Shown in FIG. 10 is a overhead view of the grip component device 10 having the body 12 configured for a right handed user which is engaged at the mounting point upon the knife 14. Also shown are the thumb positioned within the first grip path 22 and the index finger positioned within the second grip path 24.

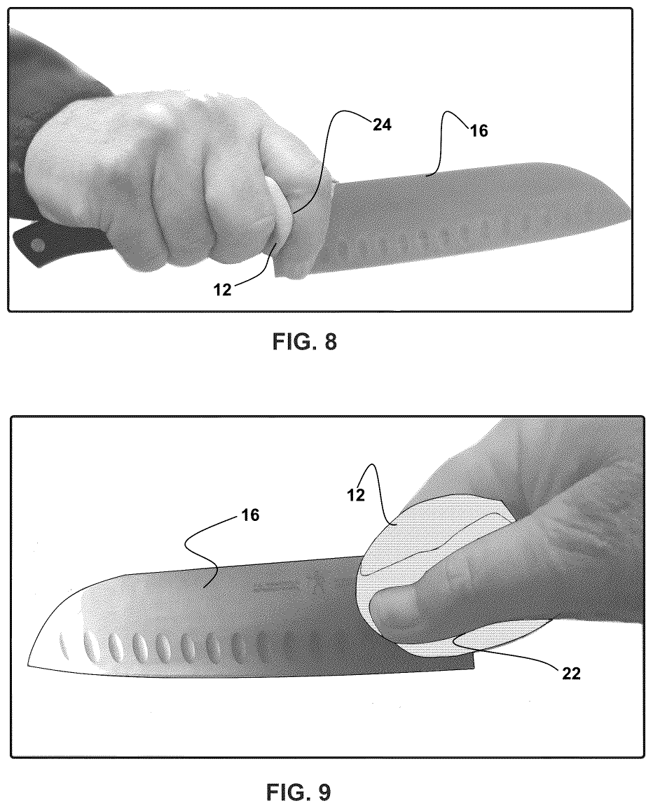

FIG. 11 shows a close up view of the grip component device 10 with the body 12 removably engaged to the engagement point on the knife 14 and the blade 16 extending forward. As can be seen, the thumb of the user is ergonomically positioned within the first grip path 22 causing it to curve horizontally toward the knife blade as well as the two fingers on the opposite side of the body 12.

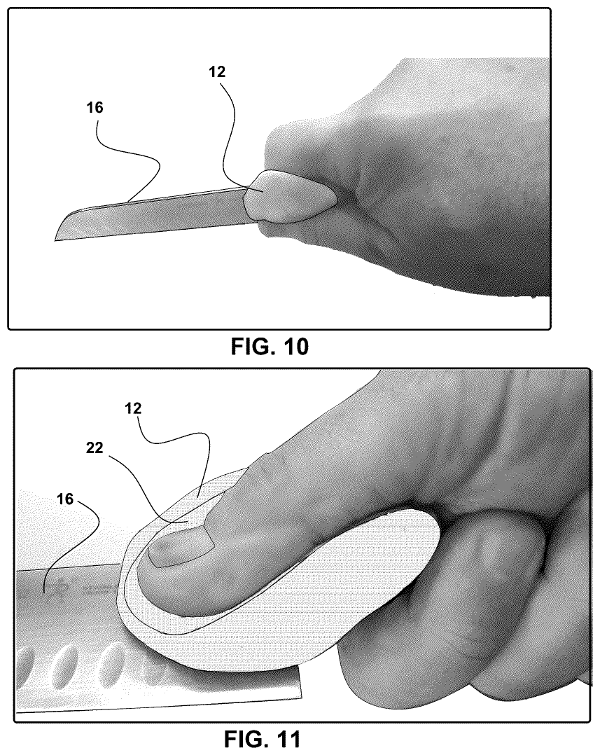

Shown in FIG. 12 is the gripping of the body 12 formed in a right handed configuration of the device from a bottom view of the grip component device 10 which is removably engaged with the knife 14. As can be seen, the thumb and fingers are operatively located in their respective grip paths. This ergonomically positions the hand of the user with the thumb of the user positioned within the first grip path 22, and the index finger and middle finger of the user curving downward along the second grip path 24 and third grip path 26. As noted, the positioning of the three grip paths are reversed on the body 12 where it is configured for left handed use, as in FIG. 12A.

Shown in FIG. 13 is a mode of the device 10 herein formed into the exterior surface of the knife handle 18 of a knife at a position adjacent the blade 16 end of the handle 18. As shown, the device 10 is configured for left handed users. As shown, the first grip path 22 extends down the right side of the handle 18 and the second grip path 24 and third grip path are on the opposite side therefrom. In FIG. 14 this configuration is reversed for a right handed user. As noted, the device can be formed directly on the exterior surface of the handle 18 during manufacture.

As noted, any of the different configurations and components shown and described herein can be employed with any other configuration or component shown and described as part of the ergonomic knife system herein. Additionally, while the disclosed invention has been described herein with reference to particular embodiments thereof and components thereof operatively engaged for operation, a latitude of equivalent modifications, various changes and substitutions are intended in the foregoing disclosures and it will be appreciated that in some instance some features, or configurations, or operations of the invention could be employed without a corresponding use of other features without departing from the scope of the invention as set forth in the following claims. All such changes, alternations and modifications as would occur to those skilled in the art subsequent to reviewing this specification, are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract included herein is neither intended to define the invention of the application, which is measured by the claims, nor is it intended to be limiting, as to the scope of the invention in any way.

What is claimed is:

1. An ergonomic grip apparatus for a knife, comprising:
a body positionable on a knife handle having a blade extending from a distal end thereof;
a first recess formed into a first side of said body, said first recess forming a first pathway for an index finger of a user; and
a second recess formed into a second side of said body, said second side of said body positioned opposite said first side thereof; and
said second recess forming a second pathway for the index finger of a user, wherein said user gripping said knife has an ergonomic positioning of said index finger and said thumb thereon.

2. The ergonomic grip apparatus for a knife of claim 1, additionally comprising:
a third recess formed into said second side of said body adjacent said second recess; and
said third recess forming a third pathway for a middle finger of said user gripping said knife.

3. The ergonomic grip apparatus for a knife of claim 1, additionally comprising:
said body being formed as a part of said handle in a unitary structure therewith.

4. The ergonomic grip apparatus for a knife of claim 1, additionally comprising:
a slot formed into a lower surface of said body;
said body being removably engageable with said knife by insertion of an upper end of said knife into said slot.

5. The ergonomic grip apparatus for a knife of claim 2, additionally comprising:
said body being formed as a part of said handle in a unitary structure therewith.

6. The ergonomic grip apparatus for a knife of claim 2, additionally comprising:
a slot formed into a lower surface of said body;
said body being removably engageable with said knife by insertion of an upper end of said knife into said slot.

7. The ergonomic grip apparatus for a knife of claim 1, configured for a right handed user.

8. The ergonomic grip apparatus for a knife of claim 1, configured for a left handed user.
